(19) United States
(12) Patent Application Publication
(10) Pub. No.: US 2017/0214049 A1
(43) Pub. Date: Jul. 27, 2017

(54) BINDER COMPOSITION FOR STORAGE BATTERY DEVICE, ELECTRODE MIXTURE FOR STORAGE BATTERY DEVICE, ELECTRODE FOR STORAGE BATTERY DEVICE AND SECONDARY BATTERY

(71) Applicant: ASAHI GLASS COMPANY, LIMITED, Chiyoda-ku (JP)

(72) Inventors: Takehiro KOSE, Chiyoda-ku (JP); Mitsuru Seki, Chiyoda-ku (JP); Naoko Sumi, Chiyoda-ku (JP); Mizuna Toyoda, Chiyoda-ku (JP)

(73) Assignee: ASAHI GLASS COMPANY, LIMITED, Chiyoda-ku (JP)

(21) Appl. No.: 15/482,176

(22) Filed: Apr. 7, 2017

Related U.S. Application Data
(63) Continuation of application No. PCT/JP2015/081779, filed on Nov. 11, 2015.

(30) Foreign Application Priority Data
Nov. 14, 2014 (JP) 2014-231895

(51) Int. Cl. H01M 4/62; H01G 11/30; H01G 11/84; H01G 11/70; C09D 127/12; H01M 10/0525; H01M 4/66; C08L 27/12; C08F 214/24; C09D 5/24; H01G 11/38; H01G 11/24

(52) U.S. Cl. CPC H01M 4/622; H01G 11/38; H01G 11/30; H01G 11/84; H01G 11/70; H01G 11/24; H01M 10/0525; H01M 4/661; C08L 27/12; C08F 214/247; C09D 5/24; C09D 127/12; H01M 2004/021

(57) ABSTRACT

To provide a binder composition for a storage battery device, which has good dispersion property and good adhesion, whereby an electrode mixture for a storage battery device will have good coating property, and a secondary battery will have good charge and discharge characteristics.

A binder composition for a storage battery device, which comprises a fluorinated copolymer comprising units (a) based on chlorotrifluoroethylene or the like, units (b) based on an alkyl vinyl ether, units (c) based on a vinyl ether having a hydroxy group or an epoxy group and units (d) based on a macromonomer having a hydrophilic portion, and a liquid medium.

### FIELD OF INVENTION

The present invention relates to a binder composition for a storage battery device, an electrode mixture for a storage battery device, an electrode for a storage battery device and a secondary battery.

### BACKGROUND OF INVENTION

A storage battery device such as a secondary battery usually comprises electrodes, a non-aqueous electrolytic solution, a separator, etc. as the main members. In general, an electrode for a storage battery is produced by applying an electrode mixture for a storage battery device, which comprises an electrode active material, an electrically conductive material, a binder and a liquid medium, on a surface of a current collector, followed by drying.

The binder for a storage battery device is usually used in the form of a binder composition having a polymer to be a binder dissolved or dispersed in water or an organic solvent, and an electrode active material and an electrically conductive material are dispersed in the binder composition to prepare an electrode mixture.

If adhesion among the electrode active material or adhesion between the electrode active material layer and the current collector is insufficient, a storage battery device having a large initial capacity cannot be obtained, and if charging and discharging of the storage battery device obtained are repeated, the capacity of the battery deteriorates due to dropout of the electrode active material from electrodes, etc. Thus, the binder for a storage battery device, to be used for the electrode mixture is required to have an excellent binding property.

Moreover, the binder for a storage battery device is required to have properties such that even if the electrode active material is covered with the binder for a storage battery device, the resistance at electrodes can be kept low, and thereby excellent charge and discharge characteristics can be realized.

Patent Document 1 shows that a binder made of an aqueous dispersion containing a fluorinated copolymer having hydrophilic groups at side chains and having a molecular weight in a specific range and a polytetrafluoroethylene (PTFE), is excellent in battery characteristics. The binder disclosed in Examples (Table 1) of Patent Document 1 is a mixture of an aqueous dispersion (A) or (B) of a fluorinated copolymer having the units (a), the units (b) and the units (c) in the present invention, and a polytetrafluoroethylene (PTFE) aqueous dispersion (G), and an electrode mixture is prepared by uniformly stirring the mixture, an electrode active material and an electrically conductive assistant.

Patent Document 2 discloses an aqueous dispersion of a fluorinated polymer, as a binder to be contained in an aqueous paste for forming a battery, and a method of mixing and using an aqueous dispersion of a crystalline fluorinated polymer such as PTFE and an aqueous dispersion of an amorphous fluorinated polymer, in order to improve the stability of the aqueous paste for forming a battery and the adhesion between an electrode active material layer and a current collector. As an example of the amorphous fluorinated polymer, a copolymer of ethyl vinyl ether, cyclohexyl vinyl ether, 4-hydroxybutyl vinyl ether and chlorotrifluoroethylene is mentioned (paragraph [0045]).

### PRIOR ART DOCUMENTS

### Patent Documents

Patent Document 1: WO2010/134465

Patent Document 2: JP-A-2011-86378

### SUMMARY OF INVENTION

### Technical Problem

Patent Documents 1 and 2 disclose aqueous dispersions of a fluorinated copolymer having the units (a), (b) and (c) in the present invention. However, in the present inventors' finding, these aqueous dispersions do not always have enough dispersion stability. For example, there is a problem such that when they are subjected to an outer force of e.g. stirring, precipitates are easily formed.

Further, Patent Documents 1 and 2 disclose mixing an aqueous dispersion of a fluorinated copolymer and an aqueous dispersion of PTFE to prepare a binder. However, in the present inventors' finding, if a shearing force is applied to PTFE, the viscosity tends to increase, whereby an electrode mixture using such a binder is difficult to have good coating property.

It is an object of the present invention to provide a binder composition for a storage battery device, which has good dispersion stability and good adhesion, whereby the coating property of an electrode mixture for a storage battery device is excellent, and excellent charge and discharge characteristics in a secondary battery can be realized, an electrode mixture for a storage battery device, which comprises the binder composition, an electrode for a storage battery device, and a secondary battery.

### Solution To Problem

The present invention has the following features [1] to [14]

[1] A binder composition for a storage battery device, which comprises a fluorinated copolymer comprising units (a) based on the following monomer (A), units (b) based on the following monomer (B), units (c) based on the following monomer (C) and units (d) based on the following monomer (D), and a liquid medium:

monomer (A): at least one compound selected from the group consisting of tetrafluoroethylene and chlorotrifluoroethylene,

monomer (B): at least one compound selected from the group consisting of a compound represented by the following formula (I) and a compound represented by the following formula (II):

CH₂═CH—(CH₂)ₙ—O—R (I)

CH₂═CH—(CH₂)ₙ—OCO—R (II)

wherein n is 0 or 1, R is a C₁₋₂₀ saturated hydrocarbon group, and when two or more compounds are used, plural n and R may be the same or different, monomer (C): at least one compound having a molecular weight of less than 300 and selected from the group consisting of a compound having an ethylenic unsaturated bond and a hydroxy group, a compound having an ethylenic unsaturated bond and an epoxy group, and a compound having an ethylenic unsaturated bond and a carboxy group, and

monomer (D): a compound which is at least one macromonomer having a hydrophilic portion and which has a molecular weight of at least 300.

[2] The binder composition for a storage battery device according to the above [1], wherein the content of the units (a) is from 20 to 80 mol %, the content of the units (b) is from 1 to 70 mol %, the content of the units (c) is from 0.1 to 40 mol %, the content of the units (d) is from 0.1 to 25 mol %, and the total of the units (a) to (d) is from 70 to 100 mol %, per the total of all units in the fluorinated copolymer.

[3] The binder composition for a storage battery device according to the above [1] or [2], wherein the monomer (C) contains at least one compound selected from the group consisting of compounds represented by the following formulae (III) to (VI):

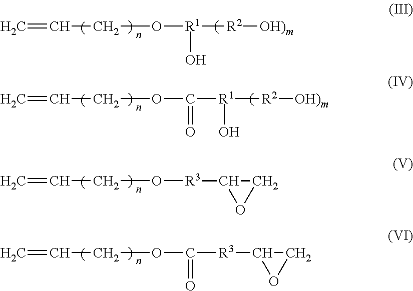

wherein n is 0 or 1, m is an integer of from 0 to 2, R¹ is a C₁₋₁₀ (m+2) valent saturated hydrocarbon group, or a C₂₋₁₀ (m+2) valent saturated hydrocarbon group having an etheric oxygen atom, R² is a C₁₋₈ bivalent saturated hydrocarbon group, or a C₂₋₈ bivalent saturated hydrocarbon group having an etheric oxygen atom, R³ is a C₁₋₈ alkylene group, or a C₂₋₈ alkylene group having an etheric oxygen atom, and when two or more compounds are used, plural m, n, R¹, R² and R³ may be the same or different.

[4] The binder composition for a storage battery device according to any one of the above [1] to [3], wherein the monomer (D) is a macromonomer in which an ethylenic unsaturated bond and —(CH₂CH₂O)ₚH (p is from 1 to 50) are bonded via a linking group containing 1,4-cyclohexylene group.

[5] The binder composition for a storage battery device according to any one of the above [1] to [4], which comprises from 5 to 70 mass % of the fluorinated copolymer and from 30 to 95 mass % of the liquid medium. [6] The binder composition for a storage battery device according to any one of the above [1] to [5], wherein the liquid medium is water alone or a mixture containing water and a water-soluble organic solvent.

[7] The binder composition for a storage battery device according to any one of the above [1] to [6], wherein the number average molecular weight of the fluorinated copolymer is from 20000 to 1000000.

[8] The binder composition for a storage battery device according to any one of the above [1] to [7], wherein the amount of precipitates to be formed in the mechanical stability test by means of a homogenizer is at most 1 mass %.

[9] A method for producing the binder composition for a storage battery device as defined in any one of the above [1] to [8], which comprises emulsion polymerizing monomer components comprising the monomers (A), (B), (C) and (D) in the liquid medium.

[10] An electrode mixture for a storage battery device, which comprises the binder composition for a storage battery device as defined in any one of the above [1] to [8] and an electrode active material.

[11] An electrode for a storage battery device, which comprises a current collector and an electrode active material layer formed on the current collector by using the electrode mixture for a storage battery device as defined in the above [10].

[12] The electrode for a storage battery device according to the above [11], wherein the peel strength between the electrode active material layer and the current collector is at least 3N.

[13] The electrode for a storage battery device according to the above [11] or

[12], wherein the press peel durability between the electrode active material layer and the current collector is at least 0.7 kN/cm.

[14] A secondary battery comprising the electrode for a storage battery device as defined in any one of the above [11] to [13] and an electrolytic solution.

### Advantageous Effects Of Invention

The binder composition for a storage battery device of the present invention has good dispersion stability and good adhesion, whereby the coating property of an electrode mixture for a storage battery device will be good, and the charge and discharge characteristics of a secondary battery will be good. Further, the reactivity in electrodes can be kept low, whereby thermal runaway in a secondary battery is less likely to occur, and higher safety can be secured.

In the electrode mixture for a storage battery device of the present invention, the electrodes for a storage battery device using the electrode mixture, and the secondary battery comprising such electrodes, adhesion among the electrode active material and adhesion between the electrode active material and a current collector are excellent, whereby good charge and discharge characteristics can be obtained, and further, the reactivity in the electrodes can be kept lower, whereby thermal runaway of the secondary battery is less likely to occur, and higher safety can be secured.

### DETAILED DESCRIPTION OF INVENTION

In the present invention, a “monomer” is a compound having a polymerizable carbon-carbon double bond (ethylenic unsaturated bond).

“Units based on a monomer” are structural units composed of monomer molecules formed by polymerizing the monomer, and a part of the monomer molecules may disappear due to decomposition.

In the present invention, unless otherwise specified, the monomer and the units based on the monomer are represented by using the same alphabet. For example, “units (a)” represent “units based on the monomer (A)”.

The number average molecular weight of a fluorinated copolymer is a value obtained as a polystyrene converted value by measuring the fluorinated copolymer by gel permeation chromatograph (GPC) using a solvent which can dissolve the fluorinated copolymer.

In the present invention, the storage battery device may, for example, be a lithium-ion primary battery, a lithium-ion secondary battery, a lithium polymer battery, an electric double layer capacitor or a lithium-ion capacitor. The storage battery device may particularly preferably be used for a lithium-ion secondary battery, since the adhesion, electric solution resistance, charge and discharge characteristics, etc. can thereby be effectively obtained.

### <Binder Composition for Storage Battery Device>

The binder composition for a storage battery device of the present invention (hereinafter referred to simply as “binder composition”) comprises a fluorinated copolymer having units (a) based on the monomer (A), units (b) based on the monomer (B), units (c) based on the monomer (C) and units (d) based on the monomer (D).

### [Monomer (A)]

The monomer (A) is at least one compound selected from the group consisting of tetrafluoroethylene (TFE) and chlorotrifluoroethylene (CTFE). The monomer (A) is preferably CTFE.

### [Monomer (B)]

The monomer (B) is at least one compound selected from the group consisting of a compound represented by the following formula (I) and a compound represented by the following formula (II).

CH₂═CH—(CH₂)ₙ—O—R (I)

CH₂═CH—(CH₂)ₙ—OCO—R (II)

wherein n is 0 or 1, and R is a C₁₋₂₀ saturated hydrocarbon group. In a case where two or more compounds are used, plural n and R may be the same or different.

The saturated hydrocarbon group as R may have a linear, branched or ring structure. R has no fluorine atom.

The carbon number of the saturated hydrocarbon group as R is from 1 to 20, and from the viewpoint of obtaining good adhesion, preferably from 2 to 15, more preferably from 2 to 10.

As specific examples of the monomer (B), a vinyl ether such as ethyl vinyl ether (EVE), propyl vinyl ether, butyl vinyl ether, 2-ethyl hexyl vinyl ether or cyclohexyl vinyl ether (CHVE); an allyl ether such as ethyl allyl ether, propyl allyl ether, butyl allyl ether or cyclohexyl allyl ether; a vinyl ester such as butyric acid vinyl ether or octanoic acid vinyl ester; and an allyl ester such as butyric acid allyl ester or octanoic acid allyl ester may be mentioned. The monomer (B) is preferably the vinyl ether or the ally ether.

### [Monomer (C)]

The monomer (C) is at least one compound having a molecular weight of less than 300 and selected from the group consisting of a compound having an ethylenic unsaturated bond and a hydroxy group, a compound having an ethylenic unsaturated bond and an epoxy group, and a compound having an ethylenic unsaturated bond and a carboxy group. The monomer (C) has at least one of a hydroxy group, an epoxy group and a carboxy group, and the monomer (C) may have at least two of them. The units based on the monomer (C) improve the adhesion.

The compound having an ethylenic unsaturated bond and a hydroxy group (hereinafter referred to also as “monomer (C-i)”) is preferably at least one compound selected from the group consisting of a vinyl ether having a hydroxy group, a vinyl ester having a hydroxy group, an allyl ether having a hydroxy group and an allyl ester having a hydroxy group. For example, the compound represented by the following formula (III) or (IV) may be mentioned.

The compound having an ethylenic unsaturated bond and an epoxy group (hereinafter referred to also as “monomer (C-ii)”) is preferably at least one compound selected from the group consisting of a vinyl ether having an epoxy group, a vinyl ester having an epoxy group, an allyl ester having an epoxy group and an allyl ester having an epoxy group. For example, the compound represented by the following formula (V) or (VI) may be mentioned.

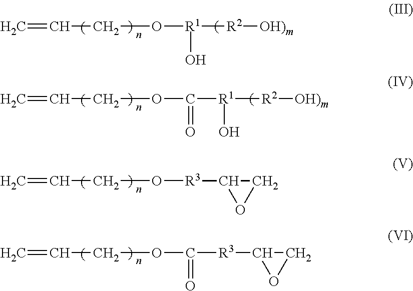

In the formula (III) to the formula (VI), n is 0 or 1. In the formula (III) and the formula (IV), m is an integer of from 0 to 2. When two or more compounds are used, plural m, n, R¹, R² and R³ may be the same or different.

In the formula (III) and the formula (IV), R¹ is a C₁₋₁₀ (m+2) valent saturated hydrocarbon group or a C₂₋₁₀ (m+2) valent saturated hydrocarbon group having an etheric oxygen atom. The saturated hydrocarbon group may be linear or branched or may have a ring structure.

The saturated hydrocarbon group as the bivalent (m=0) R¹ may, for example, be a C₁ or C₂ linear alkylene group or a C₂₋₆ saturated hydrocarbon group having from 1 to 3 etheric oxygen atoms (here, the number of etheric oxygen atoms in the C₂ saturated hydrocarbon group is 1, and the number of etheric oxygen atoms in the C₃ saturated hydrocarbon group is 1 or 2).

Specifically, an alkylene group, a cycloalkylene group or an alkylene group having a cycloalkylene group, etc. may be mentioned. The alkylene group may be linear or branched. The cycloalkylene group is preferably a C₅₋₈ cycloalkylene group, particularly preferably a cyclohexylene group. The alkylene group having a cycloalkylene group may, for example, be —CH₂—C₆H₁₀—CH₂—.

The saturated hydrocarbon group as the trivalent (m=1) or tetravalent (m=2) R¹ may, for example, be a group having m number of hydrogen atoms removed from the above mentioned bivalent saturated hydrocarbon group.

In the formula (III) and the formula (IV), R² is a C₁₋₈ bivalent saturated hydrocarbon group or a C₂₋₈ bivalent saturated hydrocarbon group having an etheric oxygen atom. The saturated hydrocarbon group may be linear or branched or may have a ring structure. As R², the same bivalent saturated hydrocarbon groups mentioned in R¹ may be mentioned.

Particularly, in the formula (III), R¹ is preferably a C₁ or C₂ linear alkylene group or a C₂₋₆ alkylene group having from 1 to 3 etheric oxygen atoms (here, the number of etheric oxygen atoms is at most 3).

Particularly, in the formula (IV), R² is preferably a C₁₋₄ alkylene group.

In the formula (V) and the formula (VI), R³ is a C₁₋₈ alkylene group or a C₂₋₈ alkylene group having an etheric oxygen atom. R³ may be linear or branched. R³ is preferably a C₁₋₄ alkylene group.

As specific examples of the monomer (C-i), a hydroxyalkyl vinyl ether such as 2-hydroxyethyl vinyl ether (HEVE), 3-hydroxypropyl vinyl ether, 2-hydroxypropyl vinyl ether, 2-hydroxy-2-methyl propyl vinyl ether, 4-hydroxybutyl vinyl ether (HBVE), 4-hydroxy-2-methyl butyl vinyl ether, 5-hydroxypentyl vinyl ether or 6-hydroxyhexyl vinyl ether; a monovinyl ether of an alicyclic diol such as cyclohexanedim ethanol monovinyl ether (CHMVE); a polyethylene glycol monovinyl ether such as diethylene glycol monovinyl ether (DEGV), triethylene glycol monovinyl ether or tetraethylene glycol monovinyl ether; a hydroxyalkyl allyl ether such as hydroxyethyl allyl ether, hydroxybutyl allyl ether, 2-hydroxyethyl allyl ether, 4-hydroxybutyl allyl ether or glycerol monoallyl ether; a hydroxyalkyl vinyl ester such as hydroxyethyl vinyl ester or hydroxybutyl vinyl ester; a hydroxyalkyl allyl ester such as hydroxyethyl allyl ester or hydroxybutyl allyl ester; and a (meth)acrylic acid hydroxyalkyl ester such as hydroxyethyl (meth)acrylate, may be mentioned.

As specific examples of the monomer (C-ii), allyl glycidyl ether, glycidyl vinyl ether, allyl-3,4-epoxybutyl ether and allyl-5,6-epoxyhexyl ether may be mentioned. As the compound having an ethylenic unsaturated bond and a carboxy group (hereinafter referred to also as “monomer (C-iii)”), for example, an unsaturated carboxylic acid such as 3-butenoic acid, 4-pentenoic acid, 2-hexenoic acid, 3-hexenoic acid, 5-hexenoic acid, 2-heptenoic acid, 3-heptenoci acid, 6-heptenoic acid, 3-octenoic acid, 7-octenoic acid, 2-nonenoic acid, 3-nonenoic acid, 8-nonenoic acid, 9-decenoic acid or 10-undecenoic acid, an acrylic acid, a methacrylic acid, a vinyl acetic acid, a crotonic acid or cinnamic acid; a saturated carboxylic acid vinyl ether such as vinyloxyvaleric acid, 3-vinyloxypropionic acid, 3-(2-vinyloxybutoxycarbonyl)propionic acid or 3-(2-vinyloxyethoxycarbonyl)propionic acid; a saturated carboxylic acid allyl ether such as allyloxyvaleric acid, 3-allyloxypropionic acid, 3-(2-allyloxybutoxycarbonyl)propionic acid or 3-(2-allyloxyethoxycarbonyl)propionic acid; a saturated multivalent carboxylic acid monovinyl ester such as monovinyl adipinoate, monovinyl succinate, vinyl phthalate or vinyl pyromellitate; an unsaturated dicarboxylic acid such as itaconic acid, maleic acid, fumaric acid, maleic acid anhydride or itaconic acid anhydride or its intermolecular acid anhydride; and an unsaturated carboxylic acid monoester such as itaconic acid monoester, maleic acid monoester or fumaric acid monoester, may be mentioned.

Among the above examples of the monomer (C-iii), crotonic acid, itaconic acid, maleic acid, maleic acid monoester, fumaric acid, fumaric acid monoester, 3-allyloxypropionic acid or 10-undecylenic acid (undecenoic acid) is preferred from the viewpoint of the copolymerization property with another fluorinated monomer and the availability.

The monomer (C) preferably contains at least one compound selected from the group consisting of the monomer (C-i) and the monomer (C-ii). The total of the monomer (C-i) and the monomer (C-ii) is preferably at least 50 mass %, more preferably at least 70 mass % or may be 100 mass %, per the total amount of the monomer (C).

The monomer (C) preferably contains at least one compound selected from the group consisting of compounds represented by the formula (III) to the formula (VI).

Among them, at least one type selected from the group consisting of HEVE, HBVE, CHMVE, DEGV, allyl glycidyl ether, 3-allyloxy-1,2-propanediol, 5-(2-propenyloxy)-1-pentanol, 6-(2-propenyloxy)-1-hexanol, 2-(2-propenyloxy)-1,4-butanediol, 4-(2-propenyloxy)-1,2-butanediol, 2-[2-(3-butenyl)ethyl]oxylane, 2-[3-(2-butenyl)propyl]oxylane and 2-[4-(2-butenyl)butyl]oxylane is preferred, at least one type selected from the group consisting of HBVE, CHMVE, allyl glycidyl ether and 3-allyloxy-1,2-propanediol is more preferred, and HBVE or CHMVE is most preferred.

The molecular weight of the monomer (C) is less than 300, preferably from 80 to 200.

### [Monomer (D)]

The monomer (D) is a compound which is at least one macromonomer having a hydrophilic portion and which has a molecular weight of at least 300.

In the present invention, a “macromonomer” is a low molecular weight-polymer or an oligomer which has an ethylenic unsaturated bond in its molecule. The molecular weight or the average molecular weight of the macromonomer is preferably from 300 to 10,000, more preferably from 400 to 5,000.

In the present specification, the molecular weight of the macromonomer is formula weight obtained based on the chemical formula. In a case of a mixture of molecules which have different molecular weights such as a mixture of molecules having different etheric chain rings, the molecular weight is represented by the average molecular weight which is an average value of molecular weights (formula weights).

A “hydrophilic portion” is a portion having a hydrophilic group, a portion having a hydrophilic bond or a portion formed by their combination.

One corresponding to any one of the monomers (A) to (C) is not included in the monomer (D).

The macromonomer is preferably one which has an ethylenic unsaturated bond in its molecule and which at the same time has a polyether chain or a polyester chain. The group having an ethylenic unsaturated bond may, for example, be a vinyl group, a vinyl ether group, a vinyl ester group, an allyl group, an allyl ether group, an allyl ester group, an acryloyl group or a methacryloyl group. The group having an ethylenic unsaturated bond is preferably a vinyl group or a vinyl ether group, since it is thereby easy to synthesize a fluorinated copolymer.

The hydrophilic group may be an ionic (anionic or cationic) hydrophilic group, a nonionic hydrophilic group, an amphoteric hydrophilic group or their combination.

The anionic hydrophilic group may, for example, be —SO₃—NH⁺₄ or —SO₃⁻Na⁺.

The cationic hydrophilic group may, for example, be —NH₃⁺CH₃COO⁻.

The nonionic hydrophilic group may, for example, be —(CH₂CH₂O)ₚH (p is from 1 to 50).

The amphoteric hydrophilic group may, for example, be —N⁺(CH₃)₂CH₂COO⁻.

From the viewpoint of the dispersion stability of the binder composition, it is preferred to combine a portion having a nonionic or amphoteric hydrophilic group and a portion having another hydrophilic group, or to combine a portion having a hydrophilic group and a portion having a hydrophilic bond.

As preferred structures of the macromonomer having a hydrophilic portion, as the monomer (D), the following (1) to (7) may, for example, be mentioned.

(1) CH₂═CHO(CH₂)ₐ[O(CH₂)_{b}]_{c}OR¹¹ (a is an inter of from 1 to 10, b is an integer of from 1 to 4, c is an integer of from 2 to 20, and R¹¹ is a hydrogen atom or a lower alkyl group);

(2) CH₂═CHCH₂O(CH₂)_{d}[O(CH₂)ₑ]_{f}OR² (d is an integer of from 1 to 10, e is an integer of from 1 to 4, f is an integer of from 2 to 20, and R² is a hydrogen atom or a lower alkyl group);

(3) CH₂═CHO(CH₂)_{g}(OCH₂CH₂)ₕ(OCH₂CH(CH₃))ₖOR³ (g is an integer of from 1 to 10, h is an integer of from 2 to 20, k is an integer of from 0 to 20, R³ is a hydrogen atom or a lower alkyl group, and the oxyethylene units and oxypropylene units may be arranged in either block or random form);

(4) CH₂═CHCH₂O(CH₂)ₘ₁(OCH₂CH₂)ₙ₁OCH₂CH(CH₃))ₚOR⁴ ((m1) is an integer of from 1 to 10, (n1) is an integer of from 2 to 20, p is an integer of from 0 to 20, R⁴ is a hydrogen atom or a lower alkyl group, and the oxyethylene units and oxypropylene units may be arranged in either block or random form);

(5) CH₂═CHO(CH₂)_{q}O(CO(CH₂)ᵣO)ₛH (q is an integer of from 1 to 10, r is an integer of from 1 to 10, and s is an integer of from 1 to 30).

The carbon number of the lower alkyl group in the above (1) to (5) is preferably from 1 to 30, more preferably from 1 to 20.

(6) A macromonomer having in its molecule, an etheric unsaturated bond and —(CH₂CH₂)ₚH (p is from 1 to 50) as a hydrophilic group which are bonded via a linking group having at least one 1,4-cyclohexylene group (hereinafter referred to also as “-cycloC₆H₁₀—”) may be mentioned.

The following may be mentioned as specific examples. (n2) is the addition mole number of oxyethylene groups and an integer of from 2 to 40.

CH₂═CHOCH₂-cycloC₆H₁₀—CH₂O(CH₂CH₂O)ₙ₂H,

CH₂═CHCH₂OCH₂-cycloC₆H₁₀—CH₂O(CH₂CH₂O)ₙ₂H,

CH₂═CHO-cycloC₆H₁₀—C(CH₃)₂-cycloC₆H₁₀—O(CH₂CH₂O)ₙ₂H,

CH₂═CHCH20-cycloC₆H₁₀—C(CH₃)₂-cycloC₆H₁₀—O(CH₂CH₂O)ₙ₂H,

CH₂═CHO-cycloC₆H₁₀—CH₂O—(CH₂CH₂O)ₙ₂—H and

CH₂═CHCH20-cycloC₆H₁₀—CH₂O—(CH₂CH₂O)ₙ₂-H.

The monomer (D) is preferably one having a vinyl ether type structure in its molecule, since the copolymerization property with a fluoroolefin is excellent. Particularly, one having a polyether chain portion comprising oxyethylene units, or oxyethylene units and oxypropylene units is preferred, since the hydrophilic property is excellent.

Further, when the monomer (D) has at least 2 oxyethylene units, properties such as stability, etc. are excellent. Further, if the number of oxyalkylene units is excessive, the solvent durability to an electrolytic solution deteriorates. The oxyalkylene units in one molecule are preferably at least 2 and at most 100, more preferably at least 2 and at most 75.

Such a macromonomer having a hydrophilic portion can be produced by a method such as polymerizing formaldehyde or a diol to a vinyl ether having a hydroxy group or to an allyl ether, or ring opening polymerizing a compound having an alkylene oxide or a lactone ring.

(7) A macromonomer having a chain formed by radical polymerization of a hydrophilic ethylenic unsaturated monomer and at a terminal, an ethylenic unsaturated bond such as a vinyloxy group or an allyloxy group, may be mentioned.

Such a macromonomer having a hydrophilic portion can be produced by the method described in Polym. Bull., 5. 335 (1981), Yamashita et al, or the like.

The macromonomer having a hydrophilic portion as the monomer (D) is available as a commercial product, and for example the following products may be mentioned.

“LATEMUL PD-104” (polyoxyalkylene alkenyl ether ammonium sulfate) and “LATEMUL PD-420” (polyoxyalkylene alkenyl ether) manufactured by Kao Corporation; “Aqualon KH-10” (polyoxyethylene-1-(allyloxymethyl)alkyl ether ammonium sulfate, “Aqualon HS-10” (polyoxyethylene nonylpropenyl phenyl ether ammonium sulfate) and “Aqualon RN-20” (polyoxyethylene nonylpropenyl phenyl ether) manufactured by DKS Co. Ltd.; “Antox MS-60” (2-sodiumsulfoethyl methacrylate), “Antox SAD” (alkyl allyl succinate sulfonic acid Na salt), “Antox MS-2N” (2-sodiumsulfoethyl methacrylate), “Antox LMA-10” (alkoxypolyethylene glycol methacrylate) and “Antox EMH-20” (alkoxypolyethylene glycol maleic acid ester) manufactured by NIPPON NYUKAZAI CO., LTD.; and ELEMINOL JS-20 and ELEMINOL RS-3000 manufactured by Sanyo Chemical Industries, Ltd., etc.

Particularly, as the monomer (D), the above (6) i.e. a macromonomer in which an ethylenic unsaturated bond and —(CH₂CH₂O)ₚH (p is from 1 to 50) are bonded via a linking group having a 1,4-cyclohexylene group, is preferred, from the viewpoint of the copolymerization property with a fluoroolefin. The group having an ethylenic unsaturated bond is preferably a vinyl ether group.

### [Another Monomer]

The fluorinated copolymer may have, in addition to units (a) to (d), units (other units (e)) based on another monomer (E) which is different from the monomers (A) to (D) and which is copolymerizable with them.

As examples of another monomer (E), an olefin such as ethylene or propylene, a vinyl type compound such as an aromatic vinyl compound such as styrene or vinyl toluene, an acryloyl compound such as butyl acrylate, a methacryloyl compound such as ethyl methacrylate, etc. may be mentioned. Particularly, an olefin is preferred.

The total of the units (a) to (d) is preferably from 70 to 100 mol %, more preferably from 80 to 100 mol %, further preferably from 90 to 100 mol %, per the total units constituting the fluorinated copolymer.

### [Content of Respective Units]

In the fluorinated copolymer, the content of the units (a) is preferably from 20 to 80 mol %, more preferably from 30 to 70 mol %, per the total of all units. When the content is at least the lower limit value in the above range, good dispersion stability tends to be obtained. When the content is at most the upper limit value, good adhesion tends to be obtained. When two types of the units (a) are contained, their total content is the “content of units (a)”. The same applies to other units.

The content of the units (b) is preferably from 1 to 70 mol %, more preferably from 5 to 60 mol %, further preferably from 10 to 50 mol %, per the total of all units. When the content is at least the lower limit value in the above range, good adhesion tends to be obtained. When the content is at most the upper limit value, a coating film having good flexibility can be easily formed. When two or more types of the units (b) are contained, their total content is the “content of units (b)”.

The content of the units (c) is preferably from 0.1 to 40 mol %, more preferably from 1 to 20 mol %, per the total of all units. When the content is at least the above lower limit value in the above range, chemical stability of an aqueous dispersion is excellent. When the content is at most the upper limit value, good adhesion tends to be obtained.

The content of the units (d) is preferably from 0.1 to 25 mol %, more preferably from 0.3 to 20 mol %, per the total of all units. When the content is at least the lower limit value in the above range, good dispersion stability tends to be obtained. That is, formation of precipitates in the after-mentioned mechanical stability test can be suppressed. When the content is at most the upper limit value, good adhesion tends to be obtained.

The average molecular weight of the fluorinated copolymer is preferably from 20,000 to 1000,000, more preferably from 20,000 to 800,000, further preferably from 20,000 to 700,000, particularly preferably from 20,000 to 500,000. When the average molecular weight is at least the lower limit value in the above range, good adhesion tends to be obtained, and when the average molecular weight is at most the above upper limit value, good dispersion stability tends to be obtained.

### <Method for Producing Fluorinated Copolymer>

The fluorinated copolymer can be produced by copolymerizing the monomers (A), (B), (C) and (D) and optionally the monomer (E) by an emulsion polymerization method. In the case of the emulsion polymerization method, a fluorinated copolymer having a high molecular weight (for example, the average molecular weight is at least 20,000) tends to be obtained.

In the emulsion polymerization method, a latex of a fluorinated copolymer is obtained via a step (hereinafter referred to also as “emulsion polymerization step”) of polymerizing (emulsion polymerizing) monomer components comprising the monomers (A) to (D) in the presence of an aqueous medium and a radical polymerization initiator and preferably an emulsifying agent.

As the emulsion polymerization method, a known method in the production of a fluorinated copolymer may be appropriately employed.

The latex to be obtained in the emulsion polymerization step may be used as the binder composition as it is in the present invention.

### <Binder Composition for Storage Battery Device>

The binder composition for a storage battery device of the present invention comprises a fluorinated copolymer and a liquid medium. The binder composition is preferably a latex having the fluorinated copolymer dispersed in the liquid medium. The latex is a dispersion of the fluorinated copolymer, and a part of the fluorinated copolymer may be dissolved in the liquid medium. The liquid medium is preferably an aqueous medium.

The aqueous medium is water alone or a mixture of water and a water-soluble organic solvent. As water, deionized water is preferably used.

As the water-soluble organic solvent, a known compound may suitably be used which is soluble in water at an optional proportion. The water-soluble organic solvent is preferably an alcohol and may, for example, be tert-butanol, propylene glycol, dipropylene glycol, dipropylene glycol monomethyl ether or tripropylene glycol. Among them, tert-butanol, propylene glycol, dipropylene glycol or dipropylene glycol monomethyl ether is preferred.

The content (solid content concentration) of the fluorinated copolymer in the binder composition is preferably from 5 to 70 mass %, more preferably from 10 to 60 mass %, particularly preferably from 15 to 55 mass %, per the total amount of the binder composition. When the content is at least the lower limit value in the above range, an electrode mixture tends to have good viscosity at the time of preparing the electrode mixture by using the binder composition, whereby thick coating can be carried out on a current collector. When the content is at most the upper limit value in the above range, good dispersion stability tends to be obtained at the time of preparing an electrode mixture by dispersing an electrode active material, etc. in the binder composition, whereby the electrode mixture tends to have good coating property.

The content of the liquid medium in the binder composition for a storage battery device of the present invention is preferably from 30 to 95 mass %, more preferably from 40 to 90 mass %, particularly preferably from 45 to 85 mass %, per the total amount of the binder composition. When the content of the liquid medium in the binder composition is at most the upper limit value in the above range, an electrode mixture will have good viscosity at the time of preparing the electrode mixture by using the binder composition, whereby thick coating can be carried out on a current collector. When the content is at least the lower limit value in the above range, dispersion stability will be good at the time of preparing an electrode mixture by dispersing an electrode active material, etc. in the binder composition, whereby the electrode mixture tends to have good uniform coating property.

The binder composition may have other components in addition to the fluorinated copolymer and the liquid medium. Such other components may, for example, be an emulsifying agent, initiator, etc. used for producing the fluorinated copolymer. The total content of components other than the fluorinated copolymer and the liquid medium is preferably at most 10 mass %, more preferably at most 1 mass %, per the total amount of the binder composition.

The binder composition of the present invention comprises the fluorinated copolymer having the units (d), whereby dispersion stability of the latex is excellent. Specifically, it is possible to obtain a binder composition, whereby in the mechanical stability test, the amount of precipitates to be formed is at most 1 mass %. The amount of precipitates to be formed being small shows that precipitates are less likely to form even when an outer force of e.g. stirring is applied, and the mechanical stability is excellent. The amount of precipitates to be formed is preferably at most 1 mass %, more preferably at most 0.1 mass %, particularly preferably at most 0.05 mass %, and the lower limit value is ideally 0 mass %.

In the mechanical stability test, a latex of the fluorinated copolymer is stirred by using a homogenizer at 25° C. at 5,000 rpm for 5 minutes and filtrated through a metal gauze made of stainless steel having 100 meshes. The filtrated residue is dried for 1 hour at 140° C., and then the amount of precipitates to be formed is calculated as the mass proportion (%) of the mass of the dried residue to the solid content in the fluorinated copolymer latex.

### <Electrode Mixture for Storage Battery Device>

The electrode mixture for a storage battery device of the present invention (sometimes referred to simply as “the electrode mixture” in this specification) comprises the binder composition of the present invention and an electrode active material. If necessary, the electrode mixture may contain an electrically conductive material and other components.

The electrode active material to be used in the present invention is not particularly restricted, and a known material may suitably be used.

As a positive electrode active material, a metal oxide such as MnO₂, V₂O₅ or V₆O₁₃; a metal sulfide such as TiS₂, MoS₂ or FeS; a lithium composite metal oxide containing a transition metal element such as Co, Ni, Mn, Fe or Ti, such as LiCoO₂, LiNiO₂ or LiMn₂O₄; or a compound having a part of the transition metal element in such a compound substituted by another metal; may be exemplified. Further, an electrically conductive polymer material such as polyacetylene or poly-p-phenylene may also be used. Still further, a part or whole of the surface thereof may be covered with a carbon material or an inorganic compound.

As a negative electrode active material, a carbide of a polymer compound such as coke, graphite, mesophase pitch microspheres, a phenol resin or polyparaphenylene; or a carbonaceous material such as vapour-grown carbon fibers or carbon fibers, may, for example, be mentioned. Further, a metal such as Si, Sn, Sb, Al, Zn or W which may be alloyed with lithium, may also be mentioned. For example, a silicon oxide represented by the formula SiOx (x is preferably from 0.5 to 1.5.) which is typical silicon monoxide may be mentioned.

As an electrode active material, one having an electrically conductive material deposited on a surface by a mechanical modification method may also be used.

In the case of an electrode mixture for a lithium-ion secondary battery, the electrode active material to be used, may be one capable of reversibly introducing and discharging lithium ions by applying an electric potential to an electrolyte, and either an inorganic compound or an organic compound may be used.

It is particularly preferred to incorporate an electrically conductive material into an electrode mixture to be used for the production of a positive electrode. By incorporating an electrically conductive material, the electrical contact in the electrode active material is improved to lower the electrical resistance in the active material layer, whereby the discharge rate of a non-aqueous secondary battery may be improved.

The electrically conductive material may, for example, be an electrically conductive carbon such as acetylene black, ketjen black, carbon black, graphite, vapor-grown carbon fibers or carbon nanotubes.

The electrode mixture preferably contains an electrically conductive material, since the effect to reduce the electrical resistance is large with an addition of a small amount of an electrically conductive material.

As another component, a known component in the electrode mixture may be used. Specifically, a water-soluble polymer such as carboxymethyl cellulose, polyvinyl alcohol, polyacrylic acid or polymethacrylic acid may be mentioned.

The proportion of the fluorinated copolymer in the electrode mixture of the present invention is preferably from 0.1 to 20 parts by mass, more preferably from 0.5 to 10 parts by mass, particularly preferably from 1 to 8 parts by mass per 100 parts by mass of the electrode active material.

Further, in a case where the electrode mixture contains the electrically conductive material, the proportion of the electrically conductive material in the electrode mixture is more than 0 part by mass, and is preferably at most 20 parts by mass, more preferably from 1 to 10 parts by mass, particularly preferably from 3 to 8 parts by mass, per 100 parts by mass of the electrode active material.

The solid content concentration in the electrode mixture is preferably from 30 to 95 mass %, more preferably from 40 to 85 mass %, particularly preferably from 45 to 80 mass %, per 100 mass % of the electrode mixture.

### <Electrode for Storage Battery Device>

The electrode for a storage battery device of the present invention comprises a current collector and an electrode active material layer containing the binder for a storage battery device of the present invention and an electrode active material, on the current collector.

The current collector is not particularly limited so long as it is made of an electrically conductive material, and it may usually be a metal foil, a metal net or a metal madreporite, of e.g. aluminum, nickel, stainless steel or copper. As a positive electrode current collector, aluminum is preferably used, and as a negative electrode current collector, copper is preferably used. The thickness of the current collector is preferably from 1 to 100 μm.

As a method for producing the electrode for a storage battery device, for example, the electrode mixture of the present invention is applied at least on one surface, preferably on both surfaces of a current collector, followed by drying to remove a medium in the electrode mixture thereby to form an electrode active material layer. If necessary, the electrode active material layer after the drying may be pressed to a desired thickness.

As a method for applying the electrode mixture to the current collector, various coating methods may be mentioned. For example, a doctor blade method, a dipping method, a reverse roll method, a direct roll method, a gravure method, an extrusion method and a brushing method may be mentioned. The coating temperature is not particularly limited, but usually a temperature in the vicinity of room temperature is preferred. The drying may be carried out by means of various drying methods, e.g. a warm air, hot air or low wet air drying method, a vacuum drying method and a drying method by irradiation with (far) infrared rays, electron rays, etc. The drying temperature is not particularly limited, but by a heating type vacuum drier, etc., a temperature of from room temperature to 200° C. is usually preferred. The pressing method may be carried out by means of a die press or a roll press.

The adhesion of the electrodes, namely, the peel strength between the electrode active material layer and the current collector is preferably high and is obtained as described below. That is, a produced electrode is cut in a strip form of 2 cm in width×10 cm in length and fixed so that the coating film surface of the electrode mixture faces upward. An adhesive tape is bonded to the coating film surface of the electrode mixture, and the adhesive tape is peeled in a 90° direction at a rate of 10 mm/min to measure the strength (N). The measurement is repeated 5 times, and the average value is taken as the peel strength. The larger the value is, the better the adhesion (bonding property) by the binder is. That is, it indicates that the adhesion among the electrode active material and the adhesion between the electrode active material and the current collector bonded by the binder are excellent. The peel strength is preferably at least 3N, more preferably at least 5N, particularly preferably at least 10N. The upper limit value is not particularly restricted, however, the upper limit value is for example, 100N.

Further, the press peel durability of the electroactive material layer and the current collector is also preferably high. That is, an electrode is produced so that the thickness of the electroactive material layer after drying would be 120 μm. The electrode is cut in a rectangular form of 25 mm in width×40 mm in length, and when roll pressed at a feed rate of 0.8 m/m in, the maximum pressure causing no peel is taken as the press peel durability. The higher the value is, the more the peeling at the time of press can be prevented. The press peel durability is preferably at least 0.7 kN/cm, more preferably 1.0 kN/cm. The upper limit value is not particularly restricted, however, the upper limit value is for example 10 kN/cm.

### <Lithium-ion Secondary Battery>

A lithium-ion secondary battery as a storage battery device has the electrode for a storage battery device of the present invention as an electrode of at least one of the cathode and the anode and has an electrolytic solution. Further, it preferably has a separator.

The electrolytic solution comprises an electrolyte and a solvent. As the solvent, an aprotic organic solvent, e.g. an alkyl carbonate such as dimethyl carbonate (DMC), ethylene carbonate (EC), diethyl carbonate (DEC), propylene carbonate (PC), butylene carbonate (BC) or methylethyl carbonate (MEC); an ester such as γ-butyrolactone or methyl formate; an ether such as 1,2-dimethoxyethane or tetrahydrofuran; or a sulfur-containing compound such as sulfolane or dimethyl sulfoxide; may be used. Particularly preferred is dimethyl carbonate, ethylene carbonate, propylene carbonate, diethyl carbonate or methylethyl carbonate, whereby a high ion conductivity is obtainable, and the useful temperature range is wide. One of these solvents may be used alone, or at least two of them may be used as mixed.

The electrolyte may be a lithium salt such as LiClO₄, LiBF₄, LiPF₆, LiAsF₅, CF₃SO₃Li or (CF₃SO₂)₂NLi.

### EXAMPLES

Now, the present invention will be described with reference to Examples, but it should be understood that the present invention is by no means limited to these Examples. Experiments and evaluations in working Examples and Comparative Examples were conducted by the following methods.

### [Method for Measuring the Composition of Fluorinated Copolymer]

The content of the units based on each monomer (composition of the copolymer) per the total of all units in the fluorinated copolymer is measured by ¹⁹F-NMR analysis, infrared adsorption spectrum analysis, fluorine-content analysis or the like.

A sample to be measured in the analysis is prepared by drying a latex of a fluorinated copolymer for 1 hour in an oven at 140° C., followed by drying for 24 hours in a vacuum drying machine (internal pressure of 10 Torr, 50° C.) and used.

### [Average Molecular Weight of Fluorinated Copolymer]

A latex of a fluorinated copolymer was dissolved in tetrahydrofuran and measured by means of GPC (model: HLC-8320) manufactured by TOSOH CORPORATION.

### [Mechanical Stability of Fluorinated Copolymer Latex (Amount of Precipitates to be Formed)]

The mechanical stability of the fluorinated copolymer latex was measured as described above.

[Coating property of Electrode Mixture for Storage Battery Device]

50 Samples having a circular shape with a diameter of 18 mm were cut out from an electrode (size of 150 mm×250 mm) produced by a method of applying an electrode mixture on a current collector by a doctor blade.

The thickness of each sample was measured to obtain an average value. Then, the difference in the thickness of 50 samples from the average value is evaluated by three grades based on the following standards (A to C: A is the best) as the index of the coating property. The better the coating property is, the more uniform the thickness of the samples tends to be.

A: The number of samples included in the range of ±10% of the average value of the thickness is at least 80% in the total samples.

B: The number of samples included in the range of ±10% of the average value of the thickness is at least 60% and the less than 80% in the total samples.

C: The number of samples included in the range of ±10% of the average value of the thickness is less than 60% in the total samples.

### [Adhesion (Peel Strength)]

The adhesion was measured as described above.

### [Adhesion (Press Peel Durability)]

The adhesion (press peel durability) was measured as described above.

### [Method for Evaluating Charge and Discharge Characteristics]

The charge and discharge characteristics of a secondary battery were evaluated by the following method.

### [Evaluation of Cathode]

### (1) Preparation of Secondary Battery (Cathode Half Cell)

A produced cathode was cut out in a circular form with a diameter of 18 mm, and a lithium metal foil and a separator made of polyethylene having the same area as the circular form, were laminated in a 2032 type coin cell in the order of the lithium metal foil, the separator and the cathode to prepare a battery element. A non-aqueous electrolytic solution was added thereto, and the cell was closed to obtain a coin type non-aqueous electrolytic solution secondary battery. As the non-aqueous electrolytic solution, a 1M-LiPF6 dissolved in a solvent (ethylmethyl carbonate:ethylene carbonate=1:1 (volume ratio)) was used.

### (2) Evaluation of Charge and Discharge Cycle Characteristics of Cathode Half Cell

The coin type non-aqueous electrolytic solution secondary battery prepared in the above (1) was charged at 25° C. at a constant current corresponding to 0.2 C to 4.3V (the voltage represents a voltage against lithium), and charging was further carried out until the current value became 0.02 C at the charging upper limit voltage, and then, discharging was carried out at a constant current corresponding to 0.2 C to 3V, to complete a cycle. The capacity retention rate (unit: %) of the discharge capacity at the 100th cycle to the discharge capacity at the first cycle was obtained and used as an index for measurement of the charge and discharge characteristics of the battery. The higher the value of the capacity retention rate is, the better the characteristics are.

Here, 1 C represents a current value to discharge a standard capacity of a battery in one hour, and 0.5 C represents a current value of ½ thereof.

### (3) Evaluation of Discharge Rate Characteristics of Cathode Half Cell

Using a coin type non-aqueous electrolytic solution secondary battery prepared in the same manner as the above (1), at 25° C., charging was carried out at a constant current corresponding to 0.2 C to 4.3V (the voltage represents a voltage against lithium), and charging was further carried out until the current value became 0.02 C at the charging upper limit voltage. Then, discharging was carried out at a constant current corresponding to 0.2 C to 3V, and then, charging was carried out in the same manner as mentioned above, and discharging was carried out at a constant current corresponding to 3 C to 3V, whereby the discharge rate characteristics were evaluated. The retention rate of the discharge capacity after 3 C discharge based on the discharge capacity after 0.2 C discharge of 100% was calculated based on the following formula to obtain the initial discharge capacity ratio. The high initial discharge capacity ratio means that the resistance in the electrode is small, and such a battery is excellent.

Discharge capacity ratio (%)=(3 C discharge capacity/0.2 C discharge capacity)×100

Then, using the battery subjected to 100 charge and discharge cycles in the charge and discharge characteristic test (2), 3 C discharge was carried out in the same manner as above, and the discharge capacity ratio after 100 cycles was calculated. A higher discharge capacity ratio after 100 cycles means that an increase of the resistance in the electrode is suppressed even after the charge and discharge cycles.

### (4) Evaluation of Cathode Reactivity

Using a coin type non-aqueous electrolytic solution secondary battery prepared in the same manner as the above (1), the following charge and discharge cycles were conducted. In cycles 1 to 4, charging was carried out at a constant current corresponding to 0.5 C to 4.2V, and charging was further carried out until the current value became 0.02 C at the charging lower limit voltage. Then, discharging was carried out at a constant current corresponding to 0.2 C to 3.0V. In cycle 5, charging was carried out at a constant current corresponding to 0.5 C to 4.3V, and charging was further carried out until the current value became 0.02 C at the charging lower limit voltage. Then, the obtained secondary battery in the charged state was disassembled under argon atmosphere to obtain a cathode in the charged state. The obtained cathode was washed with dimethyl carbonate (2 mL) three times, vacuum-dried and then punched out into a diameter of 5 mm. Then, the punched out cathode was put in a sealed container made of SUS, and 2 μL of the non-aqueous electrolytic solution in each Example was added. Then, the container was sealed to prepare a sample to be evaluated. The measurement was carried out on each obtained sample to be evaluated by a differential scanning calorimeter (DSC-6000, manufactured by SII Nano Technology Inc.) at a rate of temperature rise of 5° C./min within the temperature range of from 50 to 350° C.

The evaluation of the cathode reactivity was carried out by “exothermic peak temperature” and “calorific potential at the exothermic peak temperature”.

The “exothermic peak temperature” is a temperature showing the highest calorific potential in the above measuring temperature range, and the calorific potential (corrected value as the calorific potential at 60° C. is 0) at that temperature is “calorific potential (μW) at the exothermic peak temperature”. As the calorific potential becomes low, and the exothermic peak temperature shift to a high temperature, the reactivity of the cathode is suppressed, and a secondary battery tends not to cause thermal runaway, which shows that the safety is higher.

### [Evaluation of Anode]

### (5) Preparation of Secondary Battery (Anode Half Cell)

A produced anode was cut out in a circular form with a diameter of 18 mm, and a lithium metal foil and a separator made of polyethylene having the same area as the circular form, were laminated in a 2016 type coin cell in the order of the lithium metal foil, the separator and the anode to prepare a battery element. A non-aqueous electrolytic solution was added thereto, and the cell was closed to obtain a coin type non-aqueous electrolytic solution secondary battery. As the non-aqueous electrolytic solution, a 1M-LiPF₆ dissolved in a solvent (ethylmethyl carbonate:ethylene carbonate=1:1 (volume ratio)) was used.

### (6) Evaluation of Charge and Discharge Cycle Characteristics of Anode Half Cell

The coin type non-aqueous electrolytic solution secondary battery prepared in the above (5) was charged at 25° C. at a constant current corresponding to 0.2 C to 0.02V (the voltage represents a voltage against lithium), and charging was further carried out until the current value became 0.02C at the charging upper limit voltage, and then, discharging was carried out at a constant current corresponding to 0.2 C to 1.5V, to complete a cycle. The capacity retention rate (unit: %) of the discharge capacity at the 150th cycle to the discharge capacity at the first cycle was obtained and used as an index for measurement of the charge and discharge characteristics of the battery. The higher the value of the capacity retention rate is, the better the characteristics are.

(7) Evaluation of Discharge Rate Characteristics of Anode Using a coin type non-aqueous electrolytic solution secondary battery prepared in the same manner as the above (5), at 25° C., charging was carried out at a constant current corresponding to 0.2C to 0.02V (the voltage represents a voltage against lithium), and charging was further carried out until the current value became 0.02 C at the charging upper limit voltage, and then, discharging was carried out at a constant current corresponding to 0.2 C to 1.5V. Then, charging was carried out in the same manner as mentioned above, and discharging was carried out at a constant current corresponding to 3 C to 1.5V, whereby the discharge rate characteristics were evaluated. The retention rate of the discharge capacity after 3 C discharge based on the discharge capacity after 0.2 C discharge of 100% was calculated based on the following formula to obtain the initial discharge capacity ratio. The high initial discharge capacity ratio means that the resistance in the electrode is small, and such a battery is excellent.

Discharge capacity ratio (%)=(3 C discharge capacity/0.2 C discharge capacity)×100

Then, using the battery subjected to 100 charge and discharge cycles in the charge and discharge characteristic test (6), 2 C discharge was carried out in the same manner as above, and the discharge capacity ratio after 100 cycles was calculated. A higher discharge capacity ratio after 100 cycles means that an increase of the resistance in the electrode is suppressed even after the charge and discharge cycles.

### (8) Preparation of Secondary Battery (Anode Full Cell)

An electrode prepared by cutting out a produced anode in a circular form with a diameter of 19 mm, an electrode prepared by cutting out a produced cathode in a circular form with a diameter of 18 mm and a separator made of polyethylene were laminated in a 2032 type coin cell in the order of the anode, the separator and the cathode toward the direction of facing an electrode mixture layer to prepare a battery element.

A non-aqueous electrolytic solution was added thereto, and the cell was closed to obtain a coin type non-aqueous electrolytic solution secondary battery.

As the non-aqueous electrolytic solution, a 1M-LiPF6 dissolved in a solvent (ethylmethyl carbonate:ethylene carbonate=1:1 (volume ratio)) was used.

A cathode used for the evaluation was prepared as described below. A positive electrode mixture was obtained by mixing 100 parts by mass of LiCoO₂ having an average particle size of 10 μm as a positive electrode active material and 7 parts by mass of acetylene black as an electrically conductive material, adding 8 parts by mass of NMP and kneading them, followed by adding as a binder, NMP (solid content concentration: 12 mass %) in which PVDF was dissolved so that PVDF would be 3 parts by mass per the toal 100 parts by mass of the cathode active material. The obtained positive electrode mixture was applied to an aluminum foil (current collector) having a thickness of 15 μm by means of a doctor blade so that the thickness after drying would be 80 μm, pressed to a thickness of 60 μm and dried in a vacuum drier at 120° C. to prepare the cathode.

### (9) Evaluation of Charge and Discharge Cycle Characteristics of Anode Full Cell

The coin type non-aqueous electrolytic solution secondary battery prepared in the above (8) was charged at 25° C. at a constant current corresponding to 0.5 C to 4.35V, and charging was further carried out until the current value became 0.02 C at the charging upper limit voltage. Then, discharging was carried out at a constant current corresponding to 0.5 C to 3V, to complete a cycle. The capacity retention rate (unit: %) of the discharge capacity at the 100th cycle to the discharge capacity at the first cycle was obtained and used as an index for measurement of the charge and discharge characteristics of the battery. The higher the value of the capacity retention rate is, the better the characteristics are.

### (10) Evaluation of Discharge Rate Characteristics of Anode Full Cell

Using a coin type non-aqueous electrolytic solution secondary battery prepared in the same manner as the above (8), at 25° C., charging was carried out at a constant current corresponding to 0.5 C to 4.35V, and charging was further carried out until the current value became 0.02 C at the charging upper limit voltage. Then, discharging was carried out at a constant current corresponding to 0.1 C to 3V. Then, charging was carried out in the same manner as mentioned above, and discharging was carried out at a constant current corresponding to 2 C to 3V, whereby the charge rate characteristics were evaluated. The retention rate of the discharge capacity after 2 C discharge based on the discharge capacity after 0.1 C discharge of 100% was calculated based on the following formula to obtain the initial discharge capacity ratio. The high initial discharge capacity ratio means that the resistance in the electrode is small, and such a battery is excellent.

Discharge capacity ratio (%)=(2 C discharge capacity/0.1 C discharge capacity)×100

Then, using the battery subjected to 100 charge and discharge cycles in the charge and discharge characteristic test (9), 2 C discharge was carried out in the same manner as above, and the discharge capacity ratio after 100 cycles was calculated. A higher discharge capacity ratio after 100 cycles means that an increase of the resistance in the electrode is suppressed even after the charge and discharge cycles.

The main materials used in the Preparation Examples are mentioned below.

### <Monomer (A)>

(A1): chlorotrifluoroethylene (CTFE)

### <Monomer (B)>

(B1): 2-ethyl hexyl vinyl ether

(B2): ethyl vinyl ether (EVE)

(B3): cyclohexyl vinyl ether (CHVE)

### <Monomer (C)>

(C1): cyclohexane dimethanol monovinyl ether (CHMVE), CH₂═CHOCH₂-ctcloC₆H₁₀—CH₂OH (“cycloC₆H₁₀” is “1,4-cyclohexylene”). The same applies hereinafter.

(C2): 4-hydroxybutyl vinyl ether (HBVE)

(C3): 10-undecenoic acid

### <Monomer (D)>

(D1): CH₂═CHOCH₂-cycloC₆H₁₀—CH₂O(C₂H₄O)15H, average molecular weight: 570, manufactured by NIPPON NYUKAZAI CO., LTD.

### <Emulsifying Agent>

Nonionic emulsifying agent (1): “DKS NL-100” (product name), manufactured by DKS Co. Ltd., compound name: polyoxyethylene lauryl ether

Anionic emulsifying agent (2): sodium laurate

### <Polymerization Initiator>

Initiator (1): ammonium persulfate (APS)

Initiator (2): tert-butyl peroxypivalate

### PREPARATION EXAMPLE 1

### Preparation of Fluorinated Copolymer (F1)

Into an autoclave having an internal capacity of 250 mL made of stainless steel equipped with a stirrer, 2.8 g of a monomer (C1), 19 g of a monomer (B1), 34 g of a monomer (B3), 1.7 g of a monomer (D1), 93 g of deionized water, 0.012 g of an initiator (1), 5.2 g of a nonionic emulsifying agent (1) and 0.1 g of an anionic emulsifying agent (2) were added, and the autoclave was cooled with ice. Then, nitrogen gas was injected so that the pressure in the autoclave would be pressurized to about 0.34 MPa (3.5 kg/cm²), followed by deaeration. This pressurization and deaeration was repeated two times, and then the autoclave was deaerated to 0.001 MPa (10 mmHg) to remove dissolved air. Then, 47 g of a monomer (A1) was added, and the reaction was carried out at 50° C. for 24 hours.

After the reaction, an obtained aqueous dispersion was filtrated through a nylon cloth having 200 meshes to remove agglomerates, and thereby a fluorinated copolymer (F1) latex was obtained. The content of the fluorinated copolymer (F1) in the latex was 52 mass %.

The composition (the contents of the respective units) of the obtained fluorinated copolymer, the measured results of the number average molecular weight and the amount of formed precipitates in the mechanical stability test of the latex, are shown in Table 1 (the same applies hereinafter).

### PREPARATION EXAMPLE 2

### Preparation of Fluorinated Copolymer (F2)

Preparation Example 2 is an Example wherein the monomer (D) was not used in Preparation Example 1, i.e. the amount of the monomer (D1) to be used was 0. Otherwise, in the same manner as in Preparation Example 1, a fluorinated copolymer (F2) latex was obtained. The content of the fluorinated copolymer (F2) in the latex was 50 mass %.

### PREPARATION EXAMPLE 3

### Preparation of Fluorinated Copolymer (F3)

Preparation Example 3 is an Example to prepare a fluorinated copolymer by the solution polymerization method without using the monomer (D).

A fluorinated copolymer (F3) latex was prepared in the same manner as in the Preparation Example described in Patent document 1 at paragraphs [0078] to [0079].

That is, into a pressure-resistant reactor having an internal capacity of 250 mL, 10.3 g of a monomer (B2), 16.7 g of a monomer (C1), 15.4 g of a monomer (C2), 4.9 g of 10-undecenoic acid (C3) as another monomer, 67 g of methyl ethyl ketone (MEK) as an organic solvent, 0.6 g of an initiator (2) and 2 g of KYOWAAD 500SH were charged, and the reactor was cooled. “KYOWAAD 500SH” is an acid adsorbent (hydrotalcite comprising a double salt of magnesium and aluminium) manufactured by Kyowa Chemical Industry Co., Ltd.

The deaeration was carried out in the same manner as in Preparation Example 1 to remove dissolved air, 52.2 g of a monomer (A1) was charged, and the reaction was carried out at 50° C. for 24 hours.

After the reaction, 1.85 g of triethylamine was added to 167 g of an obtained polymer solution for neutralization, and 145 g of deionized water was slowly added while stirring. Then, MEK was distilled away under reduced pressure to obtain a fluorinated copolymer (F3) latex. The content of the fluorinated copolymer (F3) in the latex was 50 mass %.

### PREPARATION EXAMPLE 4

### Preparation of Fluorinated Copolymer (F4)

Preparation Example 4 is an Example wherein in Preparation Example 1, 16.3 g of (B2) and 20.5 g of (B3) were used without using the monomer (B1). Otherwise, in the same manner as in Preparation Example 1, a fluorinated copolymer (F4) latex was obtained. The content of the fluorinated copolymer (F4) in the latex was 50 mass %.

### PREPARATION EXAMPLE 5

### Preparation of Fluorinated Copolymer (F5)

Preparation Example 5 is an example wherein in Preparation Example 1, 29 g of (B2) and 1.1 g of (B3) were used without using the monomer (B1). The others were carried out in the same manner as in Preparation Example 1 to obtain a fluorinated copolymer (F5) latex. The content of the fluorinated copolymer (F5) in the latex was 50 mass %.

TABLE 1

| | | | Preparation Example | | | | |
|---|---|---|---|---|---|---|---|
| | | | 1 | 2 | 3 | 4 | 5 |
| Composition | Units (a) | Units (a1) | 49.8 | 50 | 52.9 | 50 | 50 |
| of | Units (b) | Units (b1) | 14.9 | 15 | — | — | — |
| fluorinated | | Units (b2) | — | — | 16.8 | 27.5 | 46.5 |
| copolymer | | Units (b3) | 32.8 | 33 | — | 20 | 1 |
| [mol %] | Units (c) | Units (c1) | 2 | 2 | 11.6 | 2 | 2 |
| | | Units (c2) | — | — | 15.6 | — | — |
| | | Units (c3) | — | — | 3.1 | — | — |
| | Units (d) | Units (d1) | 0.5 | — | — | 0.5 | 0.5 |

| | | | | | |
|---|---|---|---|---|---|
| Fluorinated copolymer | F1 | F2 | F3 | F4 | F5 |
| Number average molecular | 100,000 | 100,000 | 11,000 | 100,000 | 100,000 |
| weight | | | | | |
| Amount of precipitates formed | 0.02 | At | At | 0.02 | 0.02 |
| in mechanical stability test | | least | least | | |
| [mass %] | | 90 | 90 | | |

### EXAMPLE 1

### Preparation of Negative Electrode Mixture 1 and Preparation of Anode 1

A negative electrode mixture 1 was prepared by using the fluorinated copolymer (F1) latex obtained in Preparation Example 1 as the binder composition. Further, an anode 1 was prepared by using the negative electrode mixture 1.

That is, 40 parts by mass of a carboxymethyl cellulose aqueous solution having a concentration of 1 mass % was added as a viscosity-adjusting agent to 100 parts by mass of artificial graphite as a negative electrode active material and kneaded, followed by adding the fluorinated copolymer (F1) latex so that the fluorinated copolymer (F1) would be 5 parts by mass per 100 parts by mass of the negative electrode active material, to prepare negative electrode mixture 1.

The obtained negative electrode mixture 1 was applied to a copper foil (current collector) having a thickness of 20 μm by means of a doctor blade so that the thickness after drying would be 70 μm, and then dried in a vacuum dryer at 120° C. (inner pressure: 10 Torr, 3 hours) to prepare an anode 1.

The coating property and the adhesion (peel strength) were evaluated by the above mentioned methods. The charge and discharge characteristics (charge and discharge cycle characteristics and discharge rate characteristics) were evaluated by the above mentioned methods (5) to (7). Evaluation results are shown in Table 2 (the same applies hereinafter).

### COMPARATIVE EXAMPLE 1

### Preparation of Negative Electrode Mixture 2 and Preparation of Anode 2

A negative electrode mixture 2 and an anode 2 were prepared in the same manner as in Example 1, except that the fluorinated copolymer (F2) latex obtained in Preparation Example 2 was used as the binder composition and evaluated in the same manner.

### COMPARATIVE EXAMPLE 2

### Preparation of Negative Electrode Mixture 3 and Preparation of Anode 3

A negative electrode mixture 3 and an anode 3 were prepared in the same manner as in Example 1, except that the fluorinated copolymer (F3) latex obtained in Preparation Example 3 was used as the binder composition and evaluated in the same manner.

### COMPARATIVE EXAMPLE 3

### Preparation of Negative Electrode Mixture 4 and Preparation of Anode 4

A negative electrode mixture 4 and an anode 4 were prepared in the same manner as in Example 1, except that a styrene-butadiene copolymer (SBR) latex (solid content concentration: 50 mass %) was used as the binder composition and evaluated in the same manner.

### EXAMPLE 2

### Preparation of Negative Electrode Mixture 5 and Preparation of Anode 5

Example 2 is an Example wherein silicon monoxide was added in the negative electrode active material in Example 1.

A negative electrode mixture 5 was prepared by using the fluorinated copolymer (F1) latex obtained in Preparation Example 1 as the binder composition.

That is, as the negative electrode active material, 10 parts by mass of silicon monoxide (manufactured by Sigma-Aldrich Co. LLC.) and 90 parts by mass of artificial graphite were mixed, and then 40 parts by mass of a carboxymethyl cellulose aqueous solution having a concentration of 1 mass % as a viscosity-adjusting agent was added thereto and kneaded. Then, the fluorinated copolymer (F1) latex was added so that the fluorinated copolymer (F1) would be 5 parts by mass per the total 100 parts by mass of the negative electrode active material to prepare a negative electrode mixture 5.

The obtained negative electrode mixture 5 was applied to a copper foil (current collector) having a thickness of 20 μm by means of a doctor blade so that the thickness after drying would be 70 μm, then put in a vacuum dryer at 120° C. and dried (internal pressure: 10 Torr, 3 hours) to prepare an anode 5. The anode 5 was evaluated in the same manner as in Example 1.

### COMPARATIVE EXAMPLE 4

### Preparation of Negative Electrode Mixture 6 and Preparation of Anode 6

A negative electrode mixture 6 and an anode 6 were prepared in the same manner as in Example 2, except that the fluorinated copolymer (F2) latex obtained in Preparation Example 2 was used as the binder composition and evaluated in the same manner.

TABLE 2

| | | | | Comparative | Comparative | Comparative | | Comparative |
|---|---|---|---|---|---|---|---|---|
| | | | Example 1 | Example 1 | Example 2 | Example 3 | Example 2 | Example 4 |
| Fluorinated copolymer | | | F1 | F2 | F3 | SBR | F1 | F2 |
| Negative electrode active material | | | Graphite | | | | 10 Parts of silicon | |
| | | | | | | | monoxide and 90 | |
| | | | | | | | parts of graphite | |
| Coating property of electrode mixture | | | A | C | A | A | A | C |
| for storage battery device | | | | | | | | |
| Adhesion | | Peel strength | 14.2 | 1.5 | 2.0 | 13.0 | 8.0 | 1.1 |
| | | [N] | | | | | | |
| Evaluation of | Charge and | Capacity | 98 | 80 | 85 | 80 | 88 | 50 |
| charge and | discharge cycle | retention | | | | | | |
| discharge | characteristics | rate [%] | | | | | | |
| characteristics | Charge rate | Discharge | 93 | 85 | 88 | 75 | 88 | 75 |
| | characteristics | capacity | | | | | | |
| | (initial) | rate [%] | | | | | | |
| | Discharge rate | Charge | 90 | 50 | 75 | 40 | 80 | 30 |
| | characteristics | capacity | | | | | | |
| | (after 100 cycles) | rate [%] | | | | | | |

As shown in Table 2, in Example 1 where the latex of the fluorinated copolymer (F1) having the units (a) to (d) was used as the binder composition, adhesion among the electrode active material and adhesion between the electrode active material and the current collector were excellent, and the secondary battery comprising such a binder composition was excellent in charge and discharge characteristics, as compared with Comparative Examples 1 and 2 where the latex of the fluorinated copolymer (F2) having no units (d) or the latex of the fluorinated copolymer (F3) having no units (d) and having a small number average molecular weight was used.

In Example 3 where the latex of SBR was used as the binder composition, although the adhesion was good, the electrode resistance was large, and thereby the discharge rate characteristic was poor.

Further, also when comparing Example 2 and Comparative Example 4 where as a negative electrode active material, silicon monoxide was mixed to graphite, Example 2 was superior in adhesion and charge and discharge characteristics.

### EXAMPLE 4

### Preparation of Negative Electrode Mixture 7 and Preparation of Anode 7

A negative electrode mixture 7 and an anode 7 were prepared in the same manner as in Example 1, except that the fluorinated copolymer (F1) latex obtained in Preparation Example 1 was used as the binder composition, and the thickness after drying was made to be 120 μm and pressed to 80 μm. The charge and discharge characteristics (charge and discharge cycle characteristics and discharge rate characteristic) were evaluated by the methods described in the above (8) to (10). Evaluation results are shown in Table 4 (the same applies hereinafter).

### EXAMPLE 5

### Preparation of Negative Electrode Mixture 8 and Preparation of Anode 8

A negative electrode mixture 8 and an anode 8 were prepared in the same manner as in Example 1, except that the fluorinated copolymer (F4) latex prepared in Preparation Example 4 was used as the binder composition, and the thickness after drying was made to be 120 μm and pressed to 80 μm, and evaluated in the same manner.

### EXAMPLE 6

### Preparation of Negative Electrode Mixture 9 and Preparation of Anode 9

A negative electrode mixture 9 and an anode 9 were prepared in the same manner as in Example 1 except that the fluorinated copolymer (F5) latex prepared in Preparation Example 5 was used as the binder composition, and the thickness after drying was made to be 120 μm and pressed to 80 μm, and evaluated in the same manner.

### COMPARATIVE EXAMPLE 6

### Preparation of Negative Electrode Mixture 10 and Preparation of Anode 10

A negative electrode mixture 10 and an anode 10 were prepared in the same manner as in Example 1, except that the fluorinated copolymer (F3) latex prepared in Preparation Example 3 was used as the binder composition, and the thickness after drying was made to be 120 μm and pressed to 80 μm, and evaluated in the same manner.

### COMPARATIVE EXAMPLE 7

### Preparation of Electrode Mixture 11 and Preparation of Anode 11

A negative electrode mixture 11 and an anode 11 were prepared in the same manner as in Example 1, except that a styrene-butadiene copolymer (SBR) latex (solid content concentration: 50%) was used as the binder composition, and the thickness after drying was made to be 120 μm and pressed to 80 μm, and evaluated in the same manner.

TABLE 3

| | | | Com- | Com- | | |
|---|---|---|---|---|---|---|
| | | | parative | parative | | |
| | | Exam- | Exam- | Exam- | Exam- | Exam- |
| | | ple 4 | ple 6 | ple 7 | ple 5 | ple 6 |
| Fluorinated copolymer | | F1 | F3 | SBR | F4 | F5 |
| Negative electrode | | Graphite | | | | |
| active material | | | | | | |
| Coating property of | | A | C | B | A | A |
| electrode mixture for | | | | | | |
| storage battery device | | | | | | |
| Press peel | Peel press | 0.88 | 0.60 | 0.88 | 1.04 | 1.08 |
| durability | pressure | | | | | |
| | [kN/cm] | | | | | |

It is evident from Table 3 that adhesion among the electroactive material and adhesion between the electrode active material and the current collector in Examples 4 to 6 where the latex of the fluorinated copolymer (F1, F4 or F5) having the units (a) to (d) was used as the binder composition, are superior to those in Comparative Example 6 where the latex of the fluorinated copolymer (F3) having no units (d) and having a small average number of molecular weight was used.

TABLE 4

| | | | | Comparative | | |
|---|---|---|---|---|---|---|
| | | | Example 4 | Example 7 | Example 5 | Example 6 |
| Fluorinated copolymer | | | F1 | SBR | F4 | F5 |
| Negative electrode active material | | | Graphite | | | |
| Evaluation of charge and | Charge and discharge cycle | Capacity retention | 95 | 92 | 98 | 96 |
| discharge characteristics | characteristics | [%] | | | | |
| | Discharge rate characteristic | Discharge capacity | 92 | 93 | 96 | 94 |
| | (initial) | rate [%] | | | | |
| | Discharge rate characteristic | Discharge capacity | 89 | 90 | 91 | 91 |
| | (after 100 cycles) | rate [%] | | | | |

It is evident from Table 4 that in Examples 4 to 6 where the latex of the fluorinated copolymer (F1, F4 or F5) having the units (a) to (d) of the present invention was used as the binder composition, the anode was excellent in the full cell charge and discharge cycle characteristics. On the other hand, in Comparative Example 7 where the latex of SBR was used as the binder composition, although the adhesion was good, the electric resistance was large, and thereby the cycle characteristics were poor.

### EXAMPLE 3

### Preparation of Positive Electrode Mixture 1 and Preparation of Cathode 1

A positive electrode mixture 1 was prepared by using the fluorinated copolymer (F1) latex obtained in Preparation Example 1.

That is, 100 parts by mass of LiNi_{0.5} Mn_{0.2}Co_{0.3}O₂ having an average particle size of 10 μm as a positive electrode active material and 7 parts by mass of acetylene black as an electrically conductive material were mixed, and as a viscosity-adjusting agent, 40 parts by mass of a carboxymethyl cellulose aqueous solution having a concentration of 1 mass % was added, followed by kneading. Then, the fluorinated copolymer (F1) latex was added so that the fluorinated copolymer (F1) would be 3 parts by mass per the total 100 parts by mass of the positive electrode active material to prepare a positive electrode mixture 1.

The obtained positive electrode mixture 1 was applied to an aluminum foil (current collector) having a thickness of 15 μm by means of a doctor blade so that the thickness after drying would be 60 μm and then dried in a vacuum drier at 120° C. (inner pressure:10 Torr, 3 hours) to prepare a cathode 1.

By the above-mentioned methods, the coating property and the adhesion, (peel strength) were evaluated. By the above-mentioned methods (1) to (3), the charge and discharge characteristics (the charge and discharge cycle characteristics and the discharge rate characteristics) were evaluated. Evaluation results are shown in Table 5 (the same applies hereinafter).

### COMPARATIVE EXAMPLE 5

### Preparation of Positive Electrode Mixture 2 and Preparation of Cathode 2

A positive electrode mixture 2 and a cathode 2 were prepared in the same manner as in Example 3, except that the fluorinated copolymer (F3) latex obtained in Preparation Example 3 was used as the binder composition, and evaluated in the same manner.

### REFERENCE EXAMPLE 1

### Example of Mixing PTFE Aqueous Dispersion

A latex of a polytetrafluoroethylene (PTFE) was prepared in the same manner as in Production Example described in the above mentioned Patent Document 1 at paragraphs [0084] to [0085] and mixed with the fluorinated copolymer (F3) latex prepared in Preparation Example 3 to prepare a binder composition.

That is, 736 g of a paraffine wax, 59 L of ultrapure water and 15 g of ammonium perfluorooctanoate (APFO) as an emulsifying agent were charged into a 100 L-pressure resistant polymerization reactor. After raising the temperature to 70° C., the reactor was purged with nitrogen and deaerated, followed by introducing tetrafluoroethylene (TFE) until the inner pressure became1.9 MPa while stirring. 1 L of 0.5 mass % disuccinic acid peroxide water-soluble solution was injected thereto under pressure to initiate the polymerization. The polymerization was carried out by maintaining the polymerization pressure at 1.9 MPa for 45 minutes while supplying TFE. Then, the temperature was raised to 90° C., and 1 L of 2.5 mass % APFO water-soluble solution was added to continue heat-polymerization for 95 minutes. Then, the reactor was returned to normal temperature, and agglomerates, paraffins etc. were removed from the obtained emulsion to obtain 25.1 kg of an aqueous dispersion having the content of polytetrafluoroethylene (PTFE) of 26.0 mass % and the content of APFO of 0.05 mass %.

A nonionic surfactant comprising 0.2 kg of a polyoxyethylene (average polymerization degree of 9) lauryl ether as the main component was dissolved in the aqueous dispersion, and 0.3 kg of an anion exchange resin (“DIAION WA-30” manufactured by Mitsubishi Chemical Corporation) was dissolved, followed by stirring for 24 hours. Then the anion exchange resin was removed by filtration. Then, 0.04 kg of a 28 mass % ammonium water was added to the filtrate, followed by concentration at 80° C. for 10 hours by the phase separation method, and a supernatant liquid was removed. Then, 15 g of ammonium perfluorohexanoate (APFH) was newly added to obtain 10.5 kg of a PTFE aqueous dispersion having PTFE content of 59.7 mass %, AP FH content of 0.15 mass % and APFO content of 0.01 mass %. Further, water was added to the PTFE aqueous dispersion so that the PTFE content would be 50 mass %.

A positive electrode mixture 3 was prepared in the same manner as in Example 3, except that instead of the fluorinated copolymer (F1) used in Example 3, the above obtained PTF aqueous dispersion (PTFE content of 50 mass %) and the fluorinated copolymer (F3) latex obtained in Preparation Example 3 were used and added so that PTFE would be 1.5 parts by mass, and the fluorinated copolymer (F3) would be 1.5 parts by mass per the total 100 parts by mass of the positive electrode active material. At the time of mixing by stirring, the viscosity surged, and the positive electrode mixture 3 became highly viscous.

The cathode 3 was prepared and evaluated in the same manner as in Example 3.

### REFERENCE EXAMPLE 2

### Example of Using Fluorinated PTFE Aqueous Dispersion

A positive electrode mixture 4 was prepared in the same manner as in Example 3, except that instead of the fluorinated copolymer (F1) latex used in Example 3, the above obtained PTFE aqueous dispersion (PTFE content of 50%) was used and added so that PTFE would be 3 parts by mass per the total 100 parts by mass of the positive electrode active material. At the time of mixing by stirring, the viscosity surged, and the positive electrode mixture 4 became highly viscous.

A cathode 4 was prepared in the same manner as in Example 3 and evaluated in the same manner.

TABLE 5

| | | | | Comparative | Reference | Reference |
|---|---|---|---|---|---|---|
| | | | Example 3 | Example 5 | Example 1 | Example 2 |
| Fluorinated copolymer | | | F1 | F3 | Mixture of | PTFE |
| | | | | | F3 and | |
| | | | | | PTFE | |
| Coating property of electrode mixture | | | A | A | C | C |
| for storage battery device | | | | | | |
| Adhesion | | Peel strength | 6.7 | 1.0 | 1.0 | 0.7 |
| | | [N] | | | | |
| Charge and | Charge and discharge | Capacity retention | 95 | 82 | 80 | 75 |
| discharge | cycle characteristics | rate [%] | | | | |
| characteristics | Charge rate | Discharge capacity | 80 | 70 | 80 | 78 |
| | characteristics | ratio [%] | | | | |
| | (initial) | | | | | |
| | Discharge rate | Charge capacity | 75 | 30 | 50 | 45 |
| | characteristics | ratio [%] | | | | |
| | (after 100 cycles) | | | | | |

The cathode reactivity in Example 3 and Reference Example 2 was evaluated by the method described in the above (4). Evaluation results are shown in Table 6.

TABLE 6

| | | | Reference |
|---|---|---|---|
| | | Example 3 | Example 2 |
| Fluorinated copolymer | | F1 | PTFE |
| Cathode | Exothermic peak temperature [° C.] | 305 | 295 |
| reactivity | Calorific potential at exothermic | 3,900 | 7,000 |
| | peak temperature [μW] | | |

It is evident from Table 5 that adhesion among the electrode active material and adhesion between the electrode active material and the current collector in Example 3 where the latex of the fluorinated copolymer (F1) having the units (a) to (d) was used as the binder composition, were superior to Comparative Example 5 where the latex of the fluorinated copolymer (F3) having no units (d) and having a small number average molecular weight was used, and the secondary battery comprising the cathode in Example 3 was excellent in charge and discharge characteristics.

Further, in Reference Example 1 and Reference Example 2 where the PTFE aqueous dispersion obtained by the method described in Examples of Patent Document 1 was used, the coating property of the electrode mixture was poor, while in Examples 1 to 3 of the present invention, the coating property was good. Further, the charge and discharge characteristics in Example 3 were equivalent to or superior to those in Reference Example 1 and Reference Example 2.

Further, it is evident from Table 6 that in the cathode in Example 3 where the latex of the fluorinated copolymer (F1) having the units (a) to (d) was used as the binder composition, the calorific potential was lower than the cathode in Reference Example 2, whereby the reactivity in the cathode was more suppressed, and a secondary battery which hardly causes thermal runaway and has higher safety could be obtained.

### INDUSTRIAL APPLICABILITY

The electrode in which the electrode mixture for a storage battery, which comprises the binder composition for a storage battery of the present invention is used, is widely used as electrodes for storage battery devices such as a lithium primary battery, a lithium ion secondary battery, a lithium polymer battery, an electrical double layer capacitor and a lithium ion capacitor, particularly for a lithium ion secondary battery.

This application is a continuation of PCT Application No. PCT/JP2015/081779, filed on Nov. 11, 2015, which is based upon and claims the benefit of priority from Japanese Patent Application No. 2014-231895 filed on Nov. 14, 2014. The contents of those applications are incorporated herein by reference in their entireties.

What is claimed is:

1. A binder composition for a storage battery device, which comprises a fluorinated copolymer comprising units (a) based on the following monomer (A), units (b) based on the following monomer (B), units (c) based on the following monomer (C) and units (d) based on the following monomer (D), and a liquid medium:
monomer (A): at least one compound selected from the group consisting of tetrafluoroethylene and chlorotrifluoroethylene,
monomer (B): at least one compound selected from the group consisting of a compound represented by the following formula (I) and a compound represented by the following formula (II):
CH₂═CH—(CH₂)ₙ—O—R (I)
CH₂═CH—(CH₂)ₙ—OCO—R (II)
wherein n is 0 or 1, R is a C₁₋₂₀ saturated hydrocarbon group, and when two or more compounds are used, plural n and R may be the same or different, monomer (C): at least one compound having a molecular weight of less than 300 and selected from the group consisting of a compound having an ethylenic unsaturated bond and a hydroxy group, a compound having an ethylenic unsaturated bond and an epoxy group, and a compound having an ethylenic unsaturated bond and a carboxy group, and
monomer (D): a compound which is at least one macromonomer having a hydrophilic portion and which has a molecular weight of at least 300.

2. The binder composition for a storage battery device according to claim 1, wherein the content of the units (a) is from 20 to 80 mol %, the content of the units (b) is from 1 to 70 mol %, the content of the units (c) is from 0.1 to 40 mol %, the content of the units (d) is from 0.1 to 25 mol %, and the total of the units (a) to (d) is from 70 to 100 mol %, per the total of all units in the fluorinated copolymer.

3. The binder composition for a storage battery device according to claim 1, wherein the monomer (C) contains at least one compound selected from the group consisting of compounds represented by the following formulae (III) to (VI): 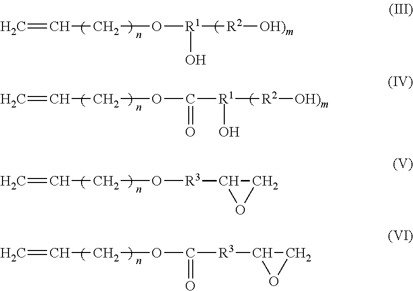
wherein n is 0 or 1, m is an integer of from 0 to 2, R¹ is a C₁₋₁₀ (m+2) valent saturated hydrocarbon group, or a C₂₋₁₀ (m+2) valent saturated hydrocarbon group having an etheric oxygen atom, R² is a C₁₋₈ bivalent saturated hydrocarbon group, or a C₂₋₈ bivalent saturated hydrocarbon group having an etheric oxygen atom, R³ is a C₁₋₈ alkylene group, or a C₂₋₈ alkylene group having an etheric oxygen atom, and when two or more compounds are used, plural m, n, R¹, R² and R³ may be the same or different.

4. The binder composition for a storage battery device according to claim 1, wherein the monomer (D) is a macromonomer in which an ethylenic unsaturated bond and —(CH₂CH₂O)ₚH (p is from 1 to 50) are bonded via a linking group containing 1,4-cyclohexylene group.

5. The binder composition for a storage battery device according to claim 1, which comprises from 5 to 70 mass % of the fluorinated copolymer and from 30 to 95 mass % of the liquid medium.

6. The binder composition for a storage battery device according to claim 1, wherein the liquid medium is water alone or a mixture containing water and a water-soluble organic solvent.

7. The binder composition for a storage battery device according to claim 1, wherein the number average molecular weight of the fluorinated copolymer is from 20,000 to 1,000,000.

8. The binder composition for a storage battery device according to claim 1, wherein the amount of precipitates to be formed in the mechanical stability test by means of a homogenizer is at most 1 mass %.

9. A method for producing the binder composition for a storage battery device as defined in claim 1, which comprises emulsion polymerizing monomer components comprising the monomers (A), (B), (C) and (D) in the liquid medium.

10. An electrode mixture for a storage battery device, which comprises the binder composition for a storage battery device as defined in claim 1 and an electrode active material.

11. An electrode for a storage battery device, which comprises a current collector and an electrode active material layer formed on the current collector by using the electrode mixture for a storage battery device as defined in claim 10.

12. The electrode for a storage battery device according to claim 11, wherein the peel strength between the electrode active material layer and the current collector is at least 3N.

13. The electrode for a storage battery device according to claim 11, wherein the press peel durability between the electrode active material layer and the current collector is at least 0.7 kN/cm.

14. A secondary battery comprising the electrode for a storage battery device as defined in claim 11 and an electrolytic solution.
